(19) United States
(12) Patent Application Publication
(10) Pub. No.: US 2025/0175707 A1
(43) Pub. Date: May 29, 2025

(54) APPARATUS, SYSTEM AND METHOD OF ACQUIRING IMAGE FOR MOBILITY

(71) Applicants: Hyundai Motor Company, Seoul (KR); Kia Corporation, Seoul (KR)

(72) Inventor: Danghee Park, Seoul (KR)

(21) Appl. No.: 18/667,390

(22) Filed: May 17, 2024

(30) Foreign Application Priority Data
Nov. 29, 2023 (KR) 10-2023-0169212

(51) Int. Cl. H04N 23/71; G02B 6/42; G02B 21/36; H04N 23/667

(52) U.S. Cl. CPC H04N 23/71; G02B 6/4204; G02B 21/361; H04N 23/667

(57) ABSTRACT

An embodiment apparatus for acquiring an image for a mobility includes a lens that allows an optical signal from a target location to pass, an optical amplifier for amplifying the optical signal that passes through the lens, a sensor that acquire an image signal included in the optical signal, an image signal processor that processes the image signal, and a plurality of reflectors that are rotatable between positions set for a night image acquisition mode and positions set for a daytime image acquisition mode, wherein, in the night image acquisition mode, the positions of the reflectors are set such that the optical signal passes through the lens to the sensor after passing through the optical amplifier, and wherein, in the daytime image acquisition mode, the positions of the reflectors are set such that the optical signal passes through the lens to the sensor without passing through the optical amplifier.

### CROSS-REFERENCE TO RELATED APPLICATIONS

This application claims the benefit of Korean Patent Application No. 10-2023-0169212, filed on Nov. 29, 2023, which application is hereby incorporated herein by reference.

### TECHNICAL FIELD

The present disclosure relates to an apparatus, a system, and a method of acquiring an image for a mobility.

### BACKGROUND

As autonomous driving technology is increasingly applied to a mobility, monitoring of passengers inside the mobility is becoming mandatory. Accordingly, it has become very important to acquire image information of the passengers inside the mobility through a camera, etc.

When using a general camera to acquire the image information inside the mobility, the image information may be acquired stably in a bright environment, but it may be difficult to stably acquire the image information such as loss of the image information when the mobility enters a tunnel or in a dark environment. Alternatively, when using an infrared camera to acquire the image information inside the mobility, it may be difficult to acquire sufficient image information to the extent that a posture or a condition of the passenger is hard to discern through the image information, and costs may increase.

The above information disclosed in this background section is only for enhancement of understanding of the background of embodiments of the invention, and therefore it may contain information that does not form the already known prior art.

### SUMMARY

The present disclosure relates to an apparatus, a system, and a method of acquiring an image for a mobility. Particular embodiments relate to an apparatus, system, and method of acquiring an image for a mobility capable of acquiring good image information in both bright and dark environments with a single integrated apparatus of acquiring an image.

Embodiments of the present disclosure provide an apparatus, a system, and a method of acquiring an image for a mobility capable of acquiring good image information in both bright and dark environments.

According to an embodiment of the present disclosure, an apparatus for acquiring an image for a mobility includes a housing, a lens mounted on one surface of the housing and configured to allow an optical signal from a target location to pass, an optical amplifier configured to amplify the passing optical signal, a sensor configured to acquire an image signal included in the optical signal, an image signal processor configured to process the image signal acquired from the sensor, and at least two reflectors configured to be rotatable between locations set for a night image acquisition mode and locations set for a daytime image acquisition mode, to transmit the optical signal passing through the lens in the daytime image acquisition mode to the sensor without passing through the optical amplifier, and to transmit the optical signal passing through the lens to the sensor after passing through the optical amplifier in the night image acquisition mode.

The apparatus may further include a filter configured to filter out the optical signal passing through the lens.

The filter may filter out the optical signal in the daytime image acquisition mode.

The number of the reflectors may be an even number.

According to another embodiment of the present disclosure, a system for acquiring an image for a mobility may include an illuminance sensor configured to measure an illuminance value of an internal or an external environment of the mobility, a controller configured to receive the illuminance value from the illuminance sensor, compare the illuminance value with a preset threshold value, generate a first control signal when the illuminance value is greater than or equal to the preset threshold, and generate a second control signal when the illuminance value is less than the preset threshold value, and an apparatus for acquiring an image including a lens configured to pass an optical signal, an optical amplifier configured to amplify the optical signal, a sensor configured to acquire an image signal included in the optical signal, an image signal processor configured to process the image signal acquired by the sensor and transmit the processed image signal to the controller, and at least two reflectors configured to change a path of the optical signal passing through the lens, wherein, when the apparatus for acquiring the image receives the first control signal from the controller, the at least two reflectors may be controlled so that the optical signal passing through the lens is transmitted to the sensor without passing through the optical amplifier, and when the apparatus for acquiring the image receives the second control signal from the controller, the at least two reflectors may be controlled so that the optical signal passing through the lens passes through the optical amplifier and then is transmitted to the sensor.

The apparatus for acquiring the image may further include a filter configured to filter out the optical signal passing through the lens.

The filter may filter out the optical signal in the daytime image acquisition mode.

The number of the reflectors may be an even number.

The threshold value may be preset according to a type of the mobility.

The controller may be further configured to transmit the processed image to a corresponding apparatus.

According to still another embodiment of the present disclosure, a method of acquiring an image for a mobility includes detecting, by an illuminance sensor, an illuminance value of an internal or an external environment of the mobility, comparing, by a controller, the illuminance value of the internal environment or the external environment of the mobility with a preset threshold value in response to receiving the illuminance value, generating, by the controller, a first control signal in response to the illuminance value being greater than or equal to the preset threshold value and transmitting the generated first control signal to an apparatus for acquiring an image, and operating, by the apparatus for acquiring the image, in a daytime image acquisition mode in response to receiving the first control signal, in which the apparatus for acquiring the image may include a lens configured to pass an optical signal, an optical amplifier configured to amplify the optical signal, a sensor configured to acquire an image signal included in the optical signal, an image signal processor configured to process the image signal acquired by the sensor and transmit the processed image signal to the controller, and at least two reflectors configured to change a path of the optical signal passing through the lens, and the apparatus for acquiring the image may control the at least two reflectors so that the optical signal passing through the lens in the daytime image acquisition mode is transmitted to the sensor without passing through the optical amplifier.

The method may further include generating, by the controller, a second control signal in response to the illuminance value being less than a preset threshold value and transmitting the generated second control signal to the apparatus for acquiring the image and operating, by the apparatus for acquiring the image, in a night image acquisition mode in response to receiving the second control signal, in which the apparatus for acquiring the image may control the at least two reflectors so that the optical signal passing through the lens in the night image acquisition mode passes through the optical amplifier and then is transmitted to the sensor.

The apparatus of acquiring an image may further include a filter configured to filter out the optical signal passing through the lens.

The filter may filter out the optical signal in the daytime image acquisition mode.

The threshold value may be preset according to a type of the mobility.

The method may further include transmitting, by the controller, the processed image to a corresponding apparatus.

According to embodiments of the present disclosure, it is possible to acquire the stable image information with a single integrated apparatus for acquiring an image even when the illuminance changes. Accordingly, it may be used as the system for securing image information for various convenience functions of the mobility, such as a passenger monitoring function and a gesture recognition function.

It is possible to reduce the costs and mounting space by integrating the apparatus for acquiring image information in the bright environment and the apparatus for acquiring image information in the dark environment into the single apparatus for acquiring an image.

Other effects that may be obtained or are predicted by exemplary embodiments will be explicitly or implicitly described in a detailed description of the exemplary embodiments. That is, various effects that are predicted according to exemplary embodiments will be described in the following detailed description.

### BRIEF DESCRIPTION OF THE DRAWINGS

Embodiments of the present specification may be better understood by referring to the following description in conjunction with the accompanying drawings, where like reference numerals refer to identical or functionally similar elements.

FIG. 1 is a block diagram of a system for acquiring an image for a mobility according to an embodiment of the present disclosure.

FIG. 2 is a schematic diagram of an apparatus for acquiring an image for a mobility according to another embodiment of the present disclosure.

FIG. 3 is a diagram schematically illustrating an inside of the apparatus for acquiring an image of FIG. 2 in a daytime image acquisition mode.

FIG. 4 is a diagram schematically illustrating an inside of the apparatus for acquiring an image of FIG. 2 in a night image acquisition mode.

FIG. 5 is a flowchart of a method of acquiring an image for a mobility according to another embodiment of the present disclosure.

It should be understood that the drawings referenced above are not necessarily drawn to scale, and they present rather simplified representations of various preferred features illustrating the basic principles of embodiments of the present disclosure. For example, specific design features of embodiments of the present disclosure, including specific dimensions, direction, position, and shape, will be determined in part by specific intended applications and use environments.

### DETAILED DESCRIPTION OF ILLUSTRATIVE EMBODIMENTS

The terminology used herein is for the purpose of describing particular embodiments only and is not intended to limit the present disclosure. As used herein, singular forms are intended to also include plural forms, unless the context clearly dictates otherwise. The terms “includes” and/or “including” specify the cited features, integers, steps, operations, elements, and/or the presence of components when used herein, but it will also be understood that these terms do not exclude the presence or addition of one or more other features, integers, steps, operations, elements, components, and/or groups thereof. As used herein, the term “and/or” includes any one or all combinations of the associated listed items.

As used in this specification, “mobility” or “of a mobility” or other similar terms include passenger vehicles including sport utility vehicles (SUVs), general land mobilities including a bus, a truck, various commercial vehicles, etc., marine mobilities including various types of boats and ships, and aerial mobilities including aircraft, a drone, etc., and include all objects that may move by receiving power from a power source. In addition, as used in this specification, “mobility” or “of a mobility” or other similar terms are understood as including a hybrid mobility, an electric mobility, a plug-in hybrid mobility, a hydrogen-powered mobility, and other alternative fuel (e.g., fuels derived from resources other than oil) mobilities. As described in this specification, the hybrid mobility includes a mobility with two or more power sources such as gasoline power and electric power. A mobility according to an embodiment of the present disclosure includes a mobility driven somewhat autonomously and/or automatically as well as a mobility driven manually.

Additionally, it is understood that one or more of the methods below or aspects thereof may be executed by at least one or more controllers. The term “controller” may refer to a hardware device including a memory and a processor. The memory is configured to store program instructions, and the processor is specifically programmed to execute the program instructions to perform one or more processes described in more detail below. The controller may control operations of units, modules, parts, devices, or the like as described herein. It is also understood that methods below may be executed by an apparatus including a controller in conjunction with one or more other components, as will be appreciated by those skilled in the art

In addition, the controller of embodiments of the present disclosure may be implemented as a non-transitory computer-readable recording medium including executable program instructions executed by a processor. Examples of the computer-readable recording medium include a ROM, a RAM, a compact disk (CD) ROM, magnetic tapes, floppy disks, flash drives, smart cards, and optical data storage devices, but the examples are not limited thereto. The computer-readable recording medium may also be distributed throughout a computer network so that the program instructions may be stored and executed in a distributed manner, for example, on a telematics server or a controller area network (CAN).

Hereinafter, exemplary embodiments of the present disclosure will be described in detail with reference to the accompanying drawings.

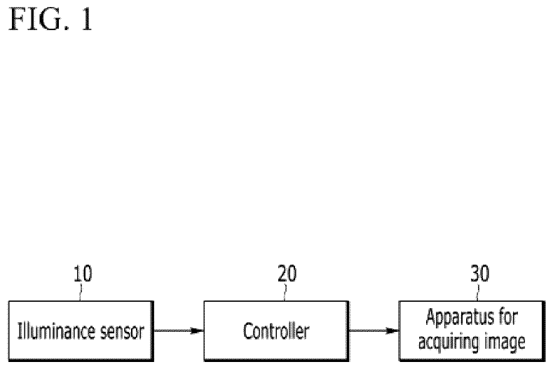

FIG. 1 is a block diagram of a system for acquiring an image for a mobility according to an embodiment of the present disclosure.

As illustrated in FIG. 1, a system for acquiring an image for a mobility according to an embodiment of the present disclosure includes an illuminance sensor 10, a controller 20, and an apparatus for acquiring an image 30 according to another embodiment of the present disclosure.

The illuminance sensor 10 is mounted inside or outside the mobility, detects an illuminance value of an internal environment of the mobility or an external environment of the mobility, and transmits information thereon to the controller 20.

The controller 20 is electrically connected to the illuminance sensor 10 and the apparatus 30. The controller 20 is configured to receive the information on the illuminance value of the internal environment or the external environment of the mobility from the illuminance sensor 10 and compare the illuminance value of the internal environment or the external environment of the mobility with a preset threshold value. Here, the threshold value may be affected by an internal structure of the mobility, an area of the windshield, etc., and therefore it may be set in advance according to a type of the mobility.

When the controller 20 determines that the illuminance value of the internal environment or the external environment of the mobility is at or above the preset threshold value, the controller 20 transmits a first control signal to the apparatus 30 so that the apparatus 30 operates in a daytime image acquisition mode. On the other hand, when the controller 20 determines that the illuminance value of the internal environment or the external environment of the mobility is less than the preset threshold value, the controller 20 transmits a second control signal to the apparatus 30 so that the apparatus 30 operates in a night image acquisition mode.

The controller 20 is configured to receive an image from the apparatus 30 and process the image. In addition, the controller 20 may perform image recognition on the processed image and transmit the processed image or the recognized image to a corresponding apparatus. For example, when the apparatus 30 acquires an image of a passenger's gesture and the controller 20 processes and recognizes the image of the passenger's gesture, the controller 20 may transmit the processed image or the recognized image to a control system of the mobility.

For this purpose, the controller 20 is provided with one or more microprocessors, and the one or more microprocessors may be programmed to perform each step of the method of acquiring an image for a mobility according to another embodiment of the present disclosure. In particular, the controller 20 includes a memory, and the memory stores various algorithms for implementing embodiments of the present disclosure, such as an image processing algorithm and an image recognition algorithm. Since these various algorithms are well known to those skilled in the art, further detailed description will be omitted.

The apparatus 30 acquires an image of a passenger, etc., at a target location and transmits a signal about the image to the controller 20. The apparatus 30 may operate in two modes: the daytime image acquisition mode and the night image acquisition mode. When the apparatus 30 receives the first control signal from the controller 20, the apparatus 30 operates in the daytime image acquisition mode, and when the apparatus 30 receives the second control signal from the controller 20, the apparatus 30 operates in the night image acquisition mode.

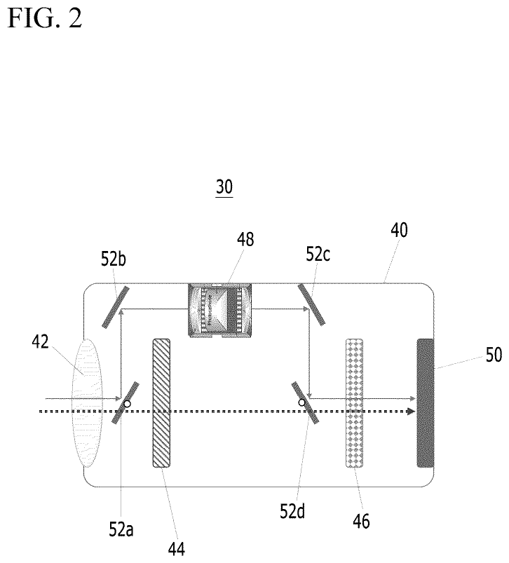

Hereinafter, with reference to FIGS. 2 to 4, the apparatus for acquiring an image for a mobility according to another embodiment of the present disclosure will be described in more detail.

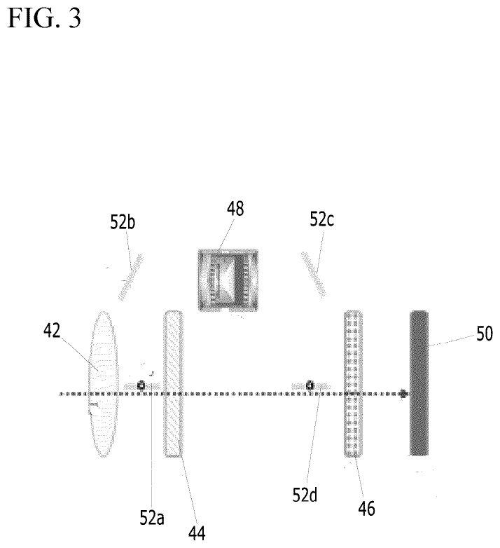

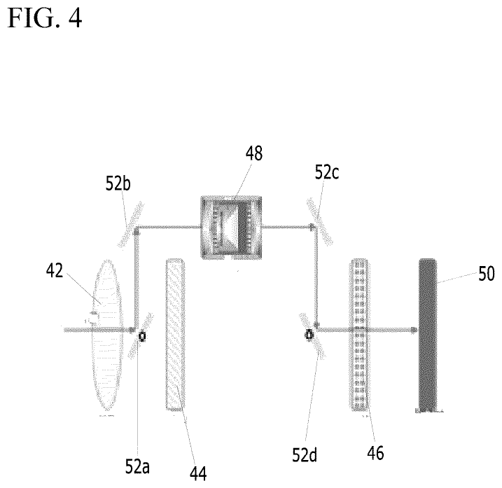

FIG. 2 is a schematic diagram of an apparatus for acquiring an image for a mobility according to another embodiment of the present disclosure, FIG. 3 is a diagram schematically illustrating an inside of the apparatus for acquiring an image of FIG. 2 in a daytime image acquisition mode, and FIG. 4 is a diagram schematically illustrating an inside of the apparatus for acquiring an image of FIG. 2 in a night image acquisition mode.

As illustrated in FIGS. 2 to 4, the apparatus 30 for acquiring an image for a mobility according to another embodiment of the present disclosure includes a housing 40, a lens 42, a filter 44, a sensor 46, an optical amplifier 48, an image signal processor 50, and at least two reflectors 52a, 52b, 52c, and 52d.

The housing 40 forms an exterior of the apparatus 30 and provides a frame for integrating the components of the apparatus 30 into one module. A space where various components of the apparatus 30 may be disposed is formed in the housing 40. Accordingly, the filter 44, the sensor 46, the optical amplifier 48, the image signal processor 50, and the at least two reflectors 52a, 52b, 52c, and 52d are disposed within the housing 40.

The lens 42 is mounted on one surface of the housing 40. An optical signal reflected from a passenger or an object at the target location enters the housing 40 through the lens 42.

The filter 44 is configured to filter out noise, etc., included in the optical signal passing through the lens 42. The optical signal passing through the filter 44 is transmitted to the sensor 46. FIGS. 2 to 4 illustrate filtering out the optical signal passing through the lens 42 in the daytime image acquisition mode, but embodiments of the present disclosure are not limited thereto. For example, it will be understood that the optical signal passing through the lens 42 may be filtered out even in the night image acquisition mode by adding the filter 44 on the path of the optical signal in the night image acquisition mode. In this case, the optical signal passing through the filter 44 is transmitted to the sensor 46 or the optical amplifier 48.

The sensor 46 reads a signal such as the image included in the optical signal. In addition, the signal such as the image is recorded in the sensor 46, so that the sensor 46 may acquire the signal such as the image included in the optical signal. The signal such as the image acquired from the sensor 46 is transmitted to the image signal processor 50.

The image signal processor 50 processes the signal such as the image acquired from the sensor 46 and transmits the processed signal to the controller 20.

Since the lens 42, the filter 44, the sensor 46, and the image signal processor 50 are the same as those used in a general digital camera, further detailed description will be omitted.

The optical amplifier 48 is disposed in the path of the optical signal in the night image acquisition mode and amplifies the optical signal passing through the lens 42 in the night image acquisition mode. The optical signal amplified by the optical amplifier 48 is transmitted to the sensor 46.

The at least two reflectors 52a, 52b, 52c, and 52d receive the first control signal or the second control signal from the controller 20 and are rotated to preset locations according to the received first control signal or second control signal. As illustrated in FIG. 3, when the at least two reflectors 52a, 52b, 52c, and 52d receive the first control signal, the at least two reflectors 52a, 52b, 52c, and 52d are rotated to the preset locations in order to acquire the daytime image acquisition mode. Accordingly, the optical signal passing through the lens 42 is transmitted to the sensor 46 without passing through the optical amplifier 48. As illustrated in FIG. 4, when the at least two reflectors 52a, 52b, 52c, and 52d receive the second control signal, the at least two reflectors 52a, 52b, 52c, and 52d are rotated to the preset locations in order to acquire the night image acquisition mode. Accordingly, the optical signal passing through the lens 42 passes through the optical amplifier 48 and then is transmitted to the sensor 46. FIGS. 2 to 4 illustrate four reflectors 52a, 52b, 52c, and 52d are used, but the number of reflectors is not limited to four. However, the number of reflectors may be an even number so that a phase of the optical signal transmitted to the sensor 46 passing through the optical amplifier 48 is the same as that of the optical signal transmitted to the sensor 46 without passing through the optical amplifier 48.

In an example, when the four reflectors 52a, 52b, 52c, and 52d are used, in the night image acquisition mode, the first reflector 52a is located downstream of the lens 42 so that the optical signal passing through the lens 42 is transmitted to the second reflector 52b, and the second reflector 52b transmits the optical signal reflected from the first reflector 52a to the optical amplifier 48. In addition, the optical signal passing through the optical amplifier 48 is incident on the third reflector 52c, the third reflector 52c transmits the optical signal to the fourth reflector 52d, and the fourth reflector 52d transmits the optical signal reflected from the third reflector 52c to the sensor 46. In the daytime image acquisition mode, the first reflector 52a and the third reflector 52c are disposed on the path of the optical signal in the daytime image acquisition mode, but they are rotated to the locations where the path of the optical signal is not changed. That is, the first reflector 52a and the third reflector 52c are rotated to the locations where the first reflector 52a and the third reflector 52c do not meet the optical signal moving from the lens 42 to the sensor 46.

As such, the apparatus 30 according to another embodiment of the present disclosure adds the at least two reflectors 52a, 52b, 52c, and 52d and the optical amplifier 48 within the housing 40 of the typical apparatus for acquiring an image and rotates the at least two reflectors 52a, 52b, 52c, and 52d when the illuminance changes such that the image information can be stably acquired.

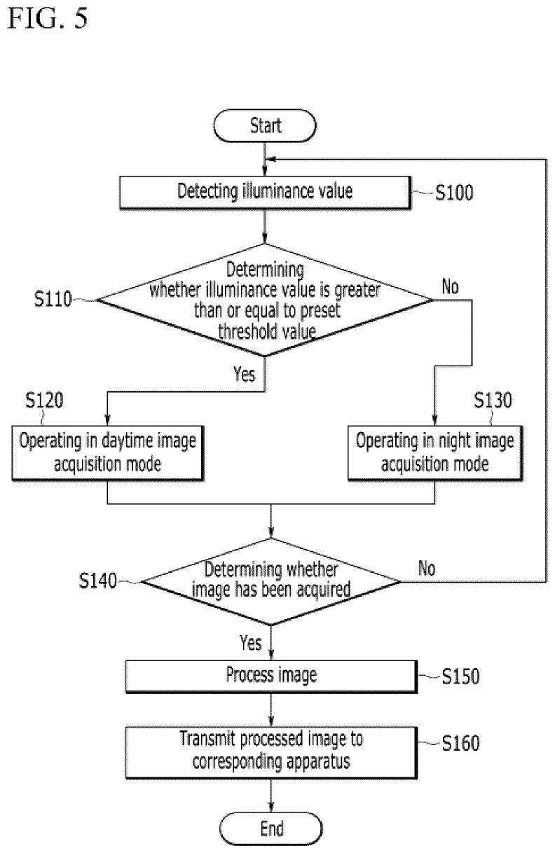

Hereinafter, a method of acquiring an image for a mobility according to another embodiment of the present disclosure will be described in detail with reference to FIG. 5.

FIG. 5 is a flowchart of a method of acquiring an image for a mobility according to another embodiment of the present disclosure.

As illustrated in FIG. 5, the method of acquiring an image for a mobility according to another embodiment of the present disclosure starts by the illuminance sensor 10 detecting the illuminance value of the internal environment or the external environment of the mobility at step S100. The illuminance sensor 10 transmits the detected illuminance value of the internal environment or the external environment of the mobility to the controller 20.

Upon receiving the illuminance value of the internal environment or the external environment of the mobility, the controller 20 determines whether the illuminance value is greater than or equal to the preset threshold value at step S110.

When it is determined at step S110 that the illuminance value is greater than or equal to the preset threshold value, the controller 20 generates the first control signal and transmits the generated first control signal to the apparatus 30. Accordingly, the apparatus 30 operates in the daytime image acquisition mode at step S120. That is, as illustrated in FIG. 3, the at least two reflectors 52a, 52b, 52c, and 52d are rotated to the locations set for the daytime image acquisition mode, and the optical signal passing through the lens 42 is transmitted to the sensor 46 without passing through the optical amplifier 48.

When it is determined at step S110 that the illuminance value is less than the preset threshold value, the controller 20 generates the second control signal and transmits the generated second control signal to the apparatus 30. Accordingly, the apparatus 30 operates in the night image acquisition mode at step S130. That is, as illustrated in FIG. 4, the at least two reflectors 52a, 52b, 52c, and 52d are rotated to the locations set for the night image acquisition mode, and the optical signal passing through the lens 42 passes through the optical amplifier 48 and then is transmitted to the sensor 46.

Upon receiving the optical signal that has passed through the optical amplifier 48 or the optical signal that has not passed through the optical amplifier 48, the sensor 46 reads the signal such as the image included in the optical signal and determines whether the image has been acquired at step S140.

When the sensor 46 acquires the image at step S140, the image signal processor 50 processes the image at step S150 and transmits the processed image to the controller 20. The controller 20 transmits the processed image to the corresponding apparatus at step S160.

When the sensor 46 fails to acquire the image at step S140, the method returns to step S100, and the illuminance sensor 10 continues to detect the illuminance value at step S100.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An apparatus for acquiring an image for a mobility, the apparatus comprising:
a housing;
a lens mounted on a surface of the housing, the lens being configured to allow an optical signal from a target location to pass;
an optical amplifier configured to amplify the optical signal that passes through the lens;
a sensor configured to acquire an image signal included in the optical signal;
an image signal processor configured to process the image signal acquired by the sensor; and
a plurality of reflectors configured to be rotatable between positions set for a night image acquisition mode and positions set for a daytime image acquisition mode, wherein, in the night image acquisition mode, the positions of the reflectors are set such that the optical signal passes through the lens to the sensor after passing through the optical amplifier, and wherein, in the daytime image acquisition mode, the positions of the reflectors are set such that the optical signal passes through the lens to the sensor without passing through the optical amplifier.

2. The apparatus of claim 1, further comprising a filter configured to filter out the optical signal passing through the lens.

3. The apparatus of claim 2, wherein the filter is configured to filter out the optical signal in the daytime image acquisition mode.

4. The apparatus of claim 1, wherein the apparatus comprises an even number of the reflectors.

5. A system for acquiring an image for a mobility, the system comprising:
an illuminance sensor configured to detect an illuminance value of an internal environment of the mobility or an external environment of the mobility;
a controller configured to receive the illuminance value from the illuminance sensor, compare the illuminance value with a preset threshold value, generate a first control signal in response to the illuminance value being greater than or equal to the preset threshold value, and generate a second control signal in response to the illuminance value being less than the preset threshold value; and
an image acquisition apparatus comprising:
a lens configured to pass an optical signal;
an optical amplifier configured to receive and amplify the optical signal;
a sensor configured to acquire an image signal included in the optical signal; and
a plurality of reflectors configured to change a path of the optical signal passing through the lens;
wherein, in a case in which the image acquisition apparatus receives the first control signal from the controller, the reflectors are configured to be controlled so that the optical signal passing through the lens is transmitted to the sensor without passing through the optical amplifier; and
wherein, in a case in which the image acquisition apparatus receives the second control signal from the controller, the reflectors are configured to be controlled so that the optical signal passing through the lens passes through the optical amplifier before being transmitted to the sensor.

6. The system of claim 5, wherein the image acquisition apparatus further comprises a filter configured to filter out the optical signal passing through the lens.

7. The system of claim 6, wherein the filter is configured to filter out the optical signal in a daytime image acquisition mode.

8. The system of claim 5, wherein the apparatus comprises an even number of the reflectors.

9. The system of claim 5, wherein the preset threshold value is preset according to a type of the mobility.

10. The system of claim 5, wherein the image acquisition apparatus further comprises an image signal processor configured to process the image signal acquired by the sensor and transmit the processed image signal to the controller.

11. The system of claim 10, wherein the controller is further configured to transmit the processed image to a corresponding apparatus.

12. A method of acquiring an image for a mobility, the method comprising:
detecting, by an illuminance sensor, an illuminance value of an internal environment of the mobility or an external environment of the mobility;
comparing, by a controller, the illuminance value of the internal environment or the external environment of the mobility with a preset threshold value in response to receiving the illuminance value;
generating, by the controller, a first control signal in response to the illuminance value being greater than or equal to the preset threshold value and transmitting the generated first control signal to an image acquisition apparatus; and
operating, by the image acquisition apparatus, in a daytime image acquisition mode in response to receiving the first control signal;
wherein the image acquisition apparatus comprises a lens that passes an optical signal, an optical amplifier, a sensor that acquires an image signal included in the optical signal, and a plurality of reflectors that change a path of the optical signal passing through the lens; and
wherein operating in the daytime image acquisition mode comprises the image acquisition apparatus controlling positions of the reflectors such that the optical signal that passes through the lens is transmitted to the sensor without passing through the optical amplifier.

13. The method of claim 12, further comprising:
generating, by the controller, a second control signal in response to the illuminance value being less than the preset threshold value and transmitting the generated second control signal to the image acquisition apparatus; and
operating, by the image acquisition apparatus, in a night image acquisition mode in response to receiving the second control signal, wherein operating in the night image acquisition mode comprises the image acquisition apparatus controlling the reflectors such that the optical signal that passes through the lens passes through the optical amplifier before being transmitted to the sensor.

14. The method of claim 13, wherein the image acquisition apparatus further comprises a filter that filters out the optical signal passing through the lens.

15. The method of claim 14, wherein the filter filters out the optical signal in the daytime image acquisition mode.

16. The method of claim 12, wherein the preset threshold value is preset according to a type of the mobility.

17. The method of claim 12, wherein the image acquisition apparatus further comprises an image signal processor that processes the image signal acquired by the sensor and transmits the processed image signal to the controller.

18. The method of claim 17, further comprising transmitting, by the controller, the processed image to a corresponding apparatus.
